(19) United States
(12) Patent Application Publication
(10) Pub. No.: US 2008/0311546 A1
(43) Pub. Date: Dec. 18, 2008

(54) Collective word building and spelling game

(76) Inventor: Darcy Ginhwa Wang, Irvine, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,940

(22) Filed: Jun. 14, 2007

(51) Int. Cl. G09B 19/22; G09B 1/32; G09B 5/00

(52) U.S. Cl. 434/129; 434/169; 434/172

(57) ABSTRACT

The present invention provides an educational language building game, in which the players collectively spell words. The game pieces may take different forms made of different materials, such as a pack of spelling cards. The virtual version of the game can be played over the computer and the Internet. The game can be played by people, with robots using artificial intelligence, or both. The game pieces include more than one set of the 26 letters of the English alphabet and multiple non-alphabet game-specific symbols. The goal of the game play is to spell a complete word, i.e. an original word, a modified word, an extended word, or a compound word, in a language based on the English or Roman alphabet system. The game can also apply to other languages, such as Chinese, which have adopted the English or Roman alphabet system as one of its spelling methods. Anyone can have fun and enjoy its educational function in playing the collective word building and spelling game whether or not his or her native language is rooted in the English or Roman alphabet system. People can play it for many reasons: building spelling abilities, improving logical thinking, developing teamwork skills, entertainment, contest, or simply for helping younger children practice spelling in the spirit of cooperation.

### BACKGROUND OF THE INVENTION

Language is a fundamental medium for communication. It is used to express ideas, thoughts, needs, and emotions by means of auditory or written symbols. The degree of knowledge of a particular language's vocabulary is critical to one's command of that language. We might know from our own experience that it can be quite frustrating to attain language proficiency. This is particularly true when it comes to learning a foreign language.

Spelling games have been designed in the past; however, they were created with the intent that each word is spelled completely by a single player. The intrinsic limitations of such approach are that players are limited to what they can spell by the letters they have on hand; that they cannot help each other spell a given word; and that the previous games limit the flexibility and variety of words that can be spelled.

Due to the foregoing limitations, most spelling games have not been widely used as educational tools to help people learn how to spell. Therefore, a new type of spelling game designed with different principles is needed to help people acquire vocabulary skills, and which is practical and effective. Hence, the collective word building and spelling game was invented.

### SUMMARY OF THE INVENTION

The present invention provides an educational language building game, in which the players collectively spell words. The game pieces may take different forms made of different materials, such as a pack of spelling cards. The virtual version of the game can be played over the computer and the Internet. The game can be played by people, with robots using artificial intelligence, or both. The collective word building and spelling game tool contains multiple sets of the 26 letters of the English alphabets (i.e. the 23 letters of the classical Latin or Roman alphabets plus the letters of J, U, W) and multiple non-alphabet, game-specific symbols such as YCSP, which can be used as any letters or symbols such as a hyphen (-), an apostrophe (') in English, or certain language-dependent symbols or numbers used for spelling in certain languages. The frequencies of letters, which vary from language to language, are considered in determining the quantity of each letter in the game pieces. In the game, players spell each word collectively. Players take turns in a predetermined sequence, placing one letter or symbol at a time. During his or her turn, a player may place a letter or symbol either before or after the existing sequence of letters and symbols.

The goal of the game is to spell a complete word, i.e. an original word, a modified word, an extended word, or a compound word, in a language based on the English or Roman alphabet system. The game can also apply to other languages, such as Chinese, which have adopted the English or Roman alphabet system as one of its spelling methods. Anyone can have fun and enjoy the educational value in playing this collective word building and spelling game whether or not his or her native language is rooted in the English or Roman alphabet system.

Accordingly, it is a primary objective of the present invention to provide a spelling game, which is played by multiple players. Each player places one letter or symbol at a time, so each word is built and spelled collectively by the players. No single player can independently determine which word will be spelled.

It is another objective of the present invention to provide a spelling game, which illustrates the flexibility of language. Whenever a letter or symbol placed, it can always change the word eventually spelled, be it an original, modified, extended, or compound word.

It is another objective of the present invention to provide a spelling game, which can apply to any language rooted in the English or Roman alphabet system, as well as in any language which has adopted the English or Roman alphabet system as one of its spelling methods.

It is another objective of the present invention to provide a spelling game, which may be played using multiple languages simultaneously.

### BRIEF DESCRIPTION OF THE DRAWING FIGURES

FIG. 1 is a schematic drawing showing the 26 letters of the English alphabets in a collective word building and spelling game according to the present invention.

FIG. 2 is a plain view showing the non-alphabet, the game-specific symbol of “YCSP” in a collective word building and spelling game according to the present invention.

FIG. 3 is a schematic drawing showing “HAPPY” built in a collective word building and spelling game according to the present invention.

FIG. 4 is a schematic drawing showing “HANDY” built in a collective word building and spelling game according to the present invention.

FIG. 5˜6A&6B are schematic drawings showing the different words developed from “SEL” in a collective world building and spelling game according to the present invention.

FIG. 7 is a schematic drawing showing the violation of rule.

FIG. 8 is a schematic drawing showing one non-alphabet, game-specific symbol of “YCSP” which is used as the letter “L” in the spelling of SPECIAL” in a collective word building and spelling game according to the present invention.

FIG. 9 is schematic drawing showing “ESPECIALLY” built in a collective word building and spelling game according to the present invention.

### DETAILED DESCRIPTION OF THE INVENTION

### Structure of the Game

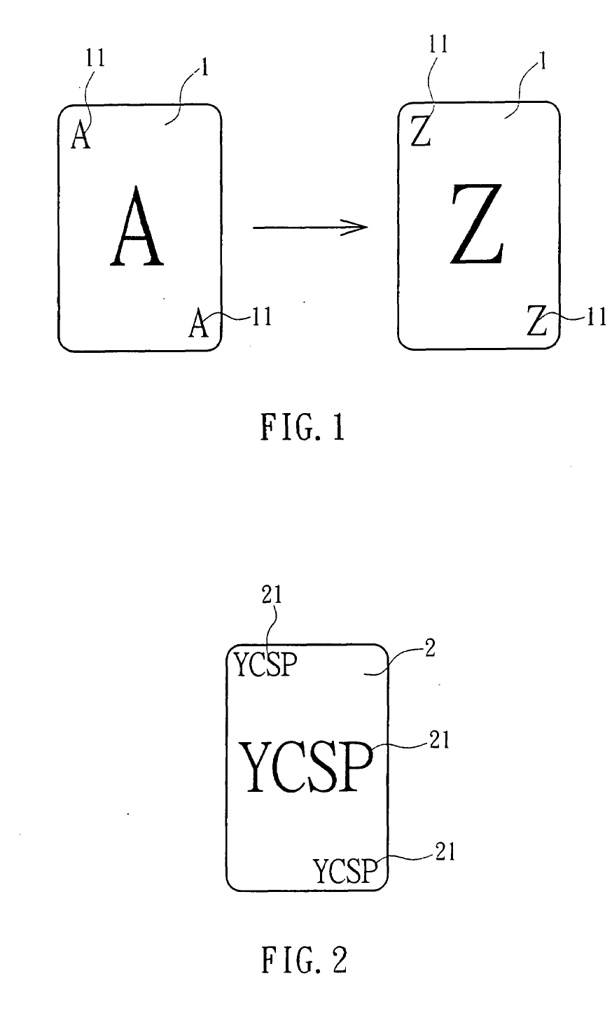

The collective word building and spelling game pieces may take different forms made of different materials, such as a pack of spelling cards. The virtual version of the game can be played over the computer and the Internet. The game can be played by people, with robots using artificial intelligence, or both. Referring now in detail to the drawing figures, FIG. 1 and FIG. 2, each pack of the spelling cards contains more than one set of cards 1 marked with the 26 letters of the English alphabets 11 (i.e. the 23 letters of the classical Latin or Roman alphabets plus the letters of J, U, W) and multiple non-alphabet cards 2 (wild cards) marked with a unique, game-specific symbol “YCSP”. Each card 1 is marked with one of the 26 English letters 11 in the center and in two the four corners on one side of the card. Each non-alphabet card 2 is marked with the sign of “YCSP” 21 in the center and in two of the four corners on one side of the card.

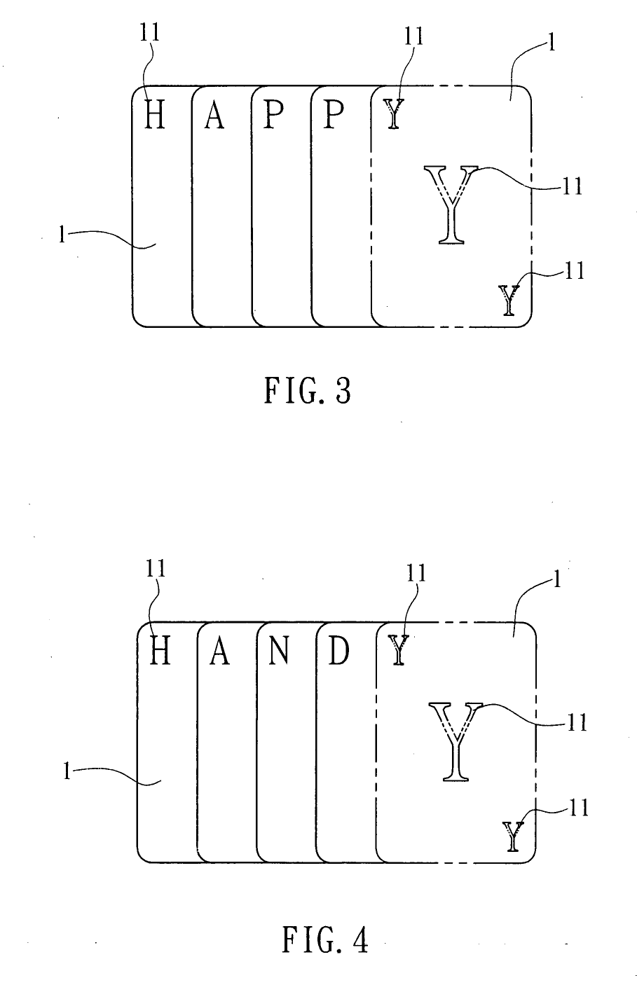

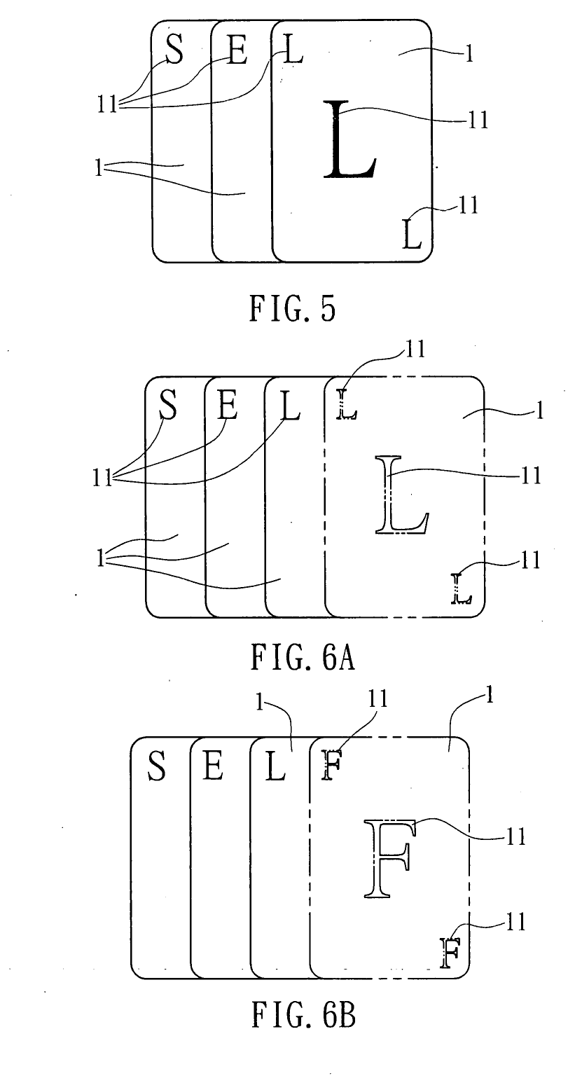

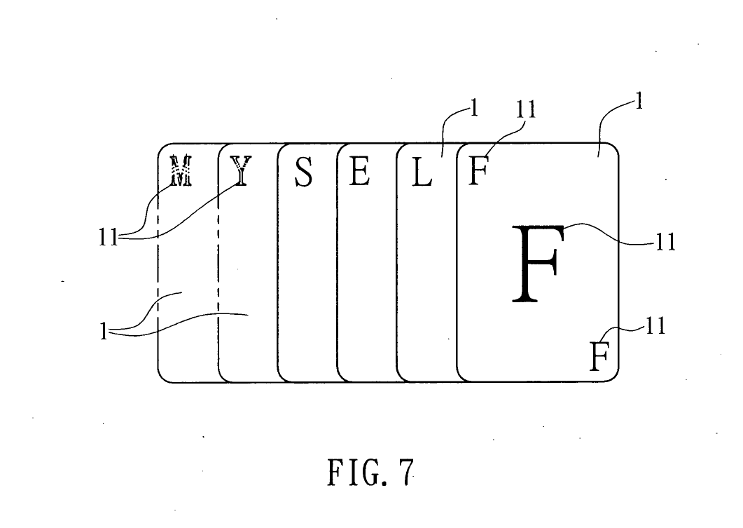

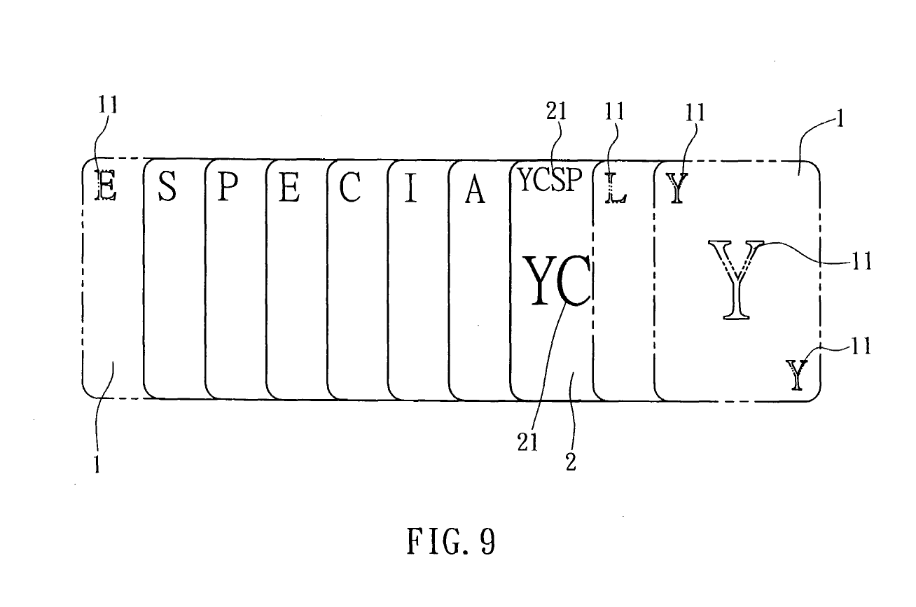

In the game, players take turns in a predetermined sequence placing one letter or symbol at a time. A player may place a letter or symbol either before or after the existing sequence of letters and symbols. For example, placing “Y” after “HAPP” to make it “HAPPY” (see FIG. 3); placing “Y” after “HAND” to make it “HANDY” (see FIG. 4); placing “E” before “SPECIAL” to build “ESPECIALLY” eventually (see FIG. 9). However, it is against the rule to place “Y” before “SELF” and then “M” before “Y” to build “MYSELF” (see FIG. 7 and Definition and Terminology below).

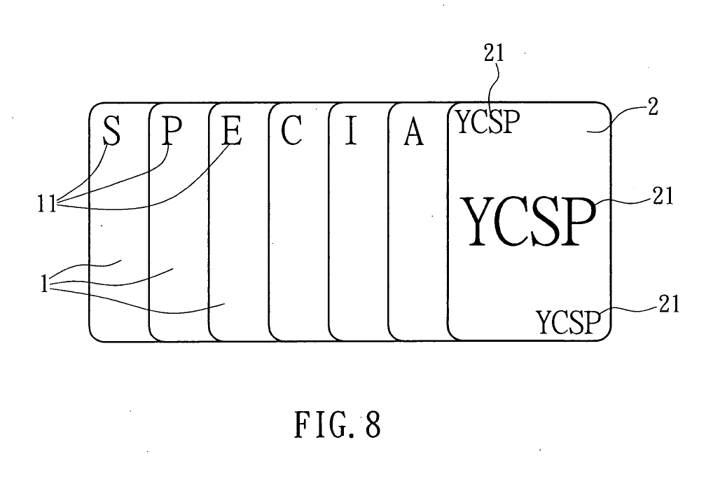

The non-alphabet, game-specific symbols 2 can be used as any letters or symbols such as hyphen (-), apostrophe (') in English, or certain language-dependent symbols used for spelling in certain languages. Each time a non-alphabet, game-specific symbol is placed, the player must explicitly state which letter or symbol that particular non-alphabet, game-specific symbol represents. For example, a non-alphabet, game-specific symbol “YCSP” can be used as “L” and added to “SPECIA” to build “SPECIAL” (see FIG. 8).

### Definition and Terminology in the Collective Word Building and Spelling Game

1. Callee: the player who is challenged.
2. Caller: the player who makes a Challenge.
3. Challenge: a Challenge is made when a player suspects a Dead End has occurred. Any player may challenge the player who placed the letter creating the suspected Dead End. A Challenge can only be made against the last letter placed.
4. Dead End: a Dead End happens when a player places a letter or symbol that ends the possibility to continue making the correct spelling of any word; e.g. when “h” is placed after “sta”, or “a” is placed after “start”.
5. Minimum Number of Letters (MNL): for example, there is only one letter in the word of “I”, it's too short, so it might not be accepted as a complete word by certain categories of the collective word building and spelling game, and hence the player does not score any point for placing it as the starting letter. MNL can be decided and set beforehand. The larger the MNL, the more challenging the game.
6. Maximum Time Allowed (MTA): time allowed for each player to think at each turn. When exceeding the MTA, it's considered as a Pass. The less the MTA, the more challenging the game.
7. Pass: if there is no letter or symbol left in the player's hand, or if none of the letter or symbol in the player's hand can continue the spelling of any words suggested by the existing cards on the table, or simply if the player wants to give up a turn for any reason, the player may skip that turn. This is defined as a Pass.
8. Player: anyone who plays the game, and it can be a computer program too, such as a virtual robot or a cartoon figure.
9. Referee: the person who validates the spelling of any given word, judges Dead End and Challenge, keeps the timer and each player's score, follows the Minimum Number of Letters and Maximum Time Allowed, and conducts the game.
10. Round: one session of the game in which words are spelled. If there is any modified word, extended word or compound word developed from an original word, it also belongs to the same round.
11. Sharing Score: when a word is built whether it is an original word, modified word, extended word, or compound word, each one of the players who has contributed any letter or symbol in the complete spelling of the given word scores points, which equals to, in a preset ratio such as 1:1 or 2:1, the total number of the letters and symbols that each player contributes in the spelling of the given word. Between Sharing Score and Winner Takes All, the game can adopt only one of them.
12. Timer: a device or a person that is responsible for keeping track of the time requirements during the game.
13. Winning Score: the predefined score. Whoever reaches or exceeds the winning score first is the winner of the game.
14. Winner Takes All: only the player who places the last letter or symbol that completes the spelling of a given word can score points. If it is an original word, the points scored equals to, in a preset ratio such as 1:1 or 2:1, the total number of the letters and symbols that build the word. If it is a modified word, extended word, or compound word, the points scored equals to, in a preset ratio such as 1:1 or 2:1, the total number of the additional letters and symbols needed to build the modified, extended word, or compound word. Between Sharing Score and Winner Takes All, the game can adopt only one of them.

### General Rules of the Collective Word Building and Spelling Game

1. To begin the game, determine which language will be used to spell the words, e.g. English, French, German, Spanish, Italian, etc. At the advanced level, players may use multiple languages for more fun and difficulty. For example, players may decide to use English and French simultaneously in the game. A dictionary of specific edition, specific publisher, or specific source of vocabularies should be selected as standard for the referee to check against the spellings and to justify words adopted from a different language. For example, “chef” is French, but it's been widely used as an English word too.
2. The words can be any tense, either gender, or either singular or plural.
3. The game can be played with one or more sets of tools of the collective word building and spelling game. Mixing multiple sets of the collective word building and spelling game may be necessary when the number of players increases, or when more letters are required for longer and more challenging words (“Massachusetts” for example).
4. The game ends when the first player reaches or exceeds the predefined winning score, such as 100 points.
5. Players may form teams. In such case, the total points scored by members of each team are tallied to decide which team wins.
6. It should be decided beforehand whether Sharing Score or Winner Takes All the game adopts; whether the points should be increased, such as doubled, when an original, modified, extended, or compound word has more letters than 8 for instance; how many sets of the collective word building and spelling game are used for the game or contest; the ratio between the points scored and the total number of letters and symbols; the playing sequence for each player and the rotation of the sequence; the winning score should be determined beforehand; the Minimum Number of Letters and the Maximum Time Allowed.
7. All letters and non-alphabet, game-specific symbols should be shuffled thoroughly before the referee deals them to all players evenly.
8. Players take turns in predetermined sequence placing one letter or symbol at a time. A player may place a letter or symbol either before or after the existing sequence of letters and symbols. For example, the next player may place “a” in front of “long” to make it “along”, and scores. If the first letter is “s”, the second player may place “e” before or after “s” to make it “es” or “se”, then the third player may place “d” before “es” or after “se” to make it “des” or “sed”. Both the second and the third players have changed the first letter of the word to be spelled. Although players may also place the next letter or symbol in the front of the existing sequence of letters and symbols, they must also follow the Dead End rule. For example, players cannot place “y” and then “m” before “self” to make it “myself”, because “yself” has already made a Dead End and violated the rule. (See FIG. 7) Another example, after “vo”, players may place “t” to make it “vot” for “vote”; or they may also place “e” in front of “vo” to make it “evo” for “evolve”, “evolution”, and etc. However, players may also place “d” in front of “evo” and make it “devo” for “devote” or “devour”, and etc. Both “evo” and “devo” are acceptable because they do not violate the Dead End rule.
9. Points to be scored when a complete word has been spelled equal to, in a preset ratio such as 1:1 or 2:1, the total number of the letters and symbols that are used to build the word. The first complete word is the original word, which can be further modified or extended. For example, “star” can be modified or extended into “start” or “stars”, then modified or extended again into “startle” or “starter”, and etc. Points to be scored for a modified or an extended word equal to, in a preset ratio such as 1:1 or 2:1, the total number of the additional letters and symbols needed to build a modified, extended, or compound word.
10. The non-alphabet, game-specific symbols can be used as any letters or symbols such as a hyphen (-), an apostrophe (') in English, or certain language-dependent symbols, tone marks, or numbers used for spelling in certain languages. For example, the numeric numbers of 0, 1, 2, 3, and 4 may be used to represent the different tones of the Chinese language when Chinese is spelled by the English or Roman alphabets. Each time a non-alphabet, game-specific symbol is placed, the player must explicitly state which letter or symbol that particular non-alphabet, game-specific symbol represents.
11. After a word has been spelled—whether it is an original word, a modified word, an extended word, or a compound word—as long as someone continues to try for more modified words, extended words or compound words, that round does not end.
12. When all players choose to pass at any time for any reasons, that round ends.
13. When a round ends, the referee should collect the letters and symbols on the table, and the game continues and starts the next round.
14. If altogether there are less than 6 letters and symbols left in all players' hands when a new round starts, all letters and symbols should be collected, reshuffled, and then dealt to the players.
15. A Challenge can be made without following the playing sequence; however, a Challenge can be made only against the last letter or symbol on the table at the time of calling.
16. If the Challenge rule is adopted for the game, (a) for a successful Challenge, the Caller scores points which equal to, in a preset ratio such as 1:1 or 2:1, the total number of the letters and symbols on the table, the Callee loses the same points, other players do not score or lose any points, and that round ends; (b) for an unsuccessful Challenge, the Caller loses points which equal to, in a preset ratio such as 1:1 or 2:1, the total number of the letters and symbols on the table, the Callee scores the same points, other players do not score or lose any points, and that round continues. If Challenge rule is adopted and the game is stalled by a possible Dead End, the referee cannot step in even if none of the players makes a Challenge, and that round ends when all players Pass.
17. If the Challenge rule is not adopted for the game, the player who makes a Dead End to the spelling loses points which equal to, in a preset ratio such as 1:1 or 2:1, the total number of the letters and symbols on the table, and other players do not score or lose any points. For example, a player loses 4 points (if 1:1) or 8 points (if 2:1) for placing “h” after “sta” or loses 6 points (if 1:1) or 12 points (if 2:1) for placing another “a” after “start”. If the Challenge rule is not adopted for the game and a Dead End happens, the referee should make judgment about the Dead End proactively before the game goes further, and that round ends.

### Basic Categories of the Collective Word Building and Spelling Game

Categories of the game play of the present invention are not limited to the following ones. Like applications of the basic principles of any invention, various combinations of certain collective word building and spelling game rules may very well be developed for more varieties of the game play. Players may choose a specific combination that meets their interests. Like playing bridge, players may develop personal strategies for playing the collective word building and spelling game in individuals or in teams.

### Category A

### For beginners or people whose vocabulary is limited; play it for learning, not winning in a contest

1. Set Minimum Number of Letters low, such as 1 letter.
2. Set Maximum Time Allowed high, such as 3 minutes or more.
3. The Challenge rule is not adopted.
4. Set Winning Score to 50 points or higher.
5. When playing Category A, may consider allowing players to use a dictionary and be tolerant with the Dead End.

### Category B

### For people who have decent knowledge of vocabulary; play it for learning or winning in a contest

1. Set Minimum Number of Letters medium, such as 2 letters or more.
2. Set Maximum Time Allowed medium, such as 2 minutes or less.
3. The Challenge rule is not adopted.
4. Set Winning Score to 100 points or higher.

### Category C

### For people who have good knowledge of vocabulary; play it as a contest

1. Set Minimum Number of Letters higher, such as letters or more.
2. Set Maximum Time Allowed lower, such 1 minutes or less.
3. The Challenge rule is not adopted.
4. Set Winning Score to 100 points or higher.

### Category D

### For people who like more challenges; play it as a contest

1. Set Minimum Number of Letters higher, such as 3 letters or more.
2. Set Maximum Time Allowed lower, such 1 minutes or less.
3. The Challenge rule is adopted.
4. Set Winning Score to 100 points or higher.

### Category E

### For people who like to play it in team and use sophisticated strategies; play it as a contest

1. Set Minimum Number of Letters higher, such as 3 letters or more.
2. Set Maximum Time Allowed lower, such 1 minutes or less.
3. The Challenge rule is adopted.
4. Play in teams. Sophisticated strategies may be developed, with which team members may make balls for each other to strike.
5. Set Winning Score to 100 points or higher.

### Category F

### For people who like to challenge themselves as “spelling masters”; play it for fun or winning in a contest

1. Set Minimum Number of Letters medium, such as 3 letters or more.
2. Set Maximum Time Allowed medium, such as 1 minutes or less.
3. The Challenge rule is adopted.
4. Adopts more than one language, e.g. English and French at the same time; or French and German at the same time; or English, Spanish and Italian at the same time; or English and Chinese at the same time. For example, in the case that both English and French are used, when letters of “recha” have been placed, either “r” or “u” may be placed to continue the spelling with the intention to develop it into “recharge” for English or “rechauffe” for French; and in the case that both English and Chinese are used, when letters of “tai” have been placed, either “n” or “4” may be placed to continue the spelling with the intention to develop it into “taint” for English or “tai⁴ji²” for Chinese (“tai⁴ji²” follows another spelling format for the words of Tai Chi; 4 and 2 represent the fourth tone and the second tone). Players must be more careful when they suspect a Dead End, because the more languages are used in this level of game, the more likely a Challenge could turn out unsuccessful.
5. Set Winning Score to 100 points or higher.

### Category G

### Play it mainly for fun

1. Set Minimum Number of Letters medium, such as 3 letters or more.
2. Set Maximum Time Allowed medium, such as 1 minutes or less.
3. Challenge rule is adopted.
4. The words are spelled in reverse in the game. For example, “book” is spelled as “koob”.
5. Set Winning Score to 100 points or higher.

### Category H

### For people who are becoming “magicians” in spelling; play it mainly for fun

1. Set Minimum Number of Letters medium, such as 3 letters or more.
2. Set Maximum Time Allowed medium, such as 1 minutes or less.
3. The Challenge rule is adopted.
4. More than one language is adopted.
5. The words are spelled in reverse in the game.
6. Set Winning Score to 100 points or higher.

While the invention has been disclosed in preferred forms for purposes of illustration, many variations and modifications may be made to the above-described embodiment(s) of the invention without departing substantially from the spirit and principles of the invention.

What is claimed is:

1. A collective word building and spelling game comprising:
multiple sets of the 26 letters of the English alphabets; the frequencies of letters, which vary from language to language, are considered in determining the quantity of each letter in the game pieces; and
multiple non-alphabet, game-specific symbols which can be used as any letters or symbols such as a hyphen (-) and an apostrophe (') in English, or as certain language-dependent symbols or numbers used for spelling in certain languages, and the player must explicitly state which letter or symbol that particular non-alphabet, game-specific symbol represents each time a non-alphabet, game-specific symbol is placed.

2. A collective word building and spelling game of claim 1 wherein the English alphabet and the non-alphabet, game-specific symbols are marked on the game tool which can be made of any material in any form such as a pack of spelling cards.

3. A collective word building and spelling game of claim 1 wherein said game pieces may take different forms made of different materials. The virtual version of the game can be played over the computer and the Internet. The game can be played by people, with robots using artificial intelligence, or both.

4. A collective word building and spelling game of claim 1 wherein the game can apply to any language rooted in the English or Roman alphabet system as well as any language which has adopted the English or Roman alphabet system as one of its spelling methods.

5. A collective word building and spelling game of claim 1 wherein multiple languages can be adopted simultaneously for words to be spelled.

6. A collective word building and spelling game of claim 1 wherein each player places one letter or symbol at a time, so each word is built and spelled by all players collectively, and no single player can determine independently which word the spelling will end up at

7. A collective word building and spelling game of claim 1 wherein players take turns in predetermined sequence placing one letter or symbol at a time. Player may place it in the front of the first letter of the existing sequence of letters and symbols or after the last letter.

8. A collective word building and spelling game of claim 1 wherein a round may continue for modified words, extended words or compound words after an original word has been spelled.

9. A collective word building and spelling game of claim 1 wherein at the adoption of SS rule (sharing score), when a complete word is spelled whether it is an original word, a modified word, an extended word, or a compound word, each one of the players who has contributed any letter or symbol in the complete spelling of the given word scores points, which equal to, in a preset ratio, the total number of the letters and symbols that each player contributes in the spelling of the given word.

10. A collective word building and spelling game of claim 1 wherein at the adoption of Winner Takes All rule, only the player who places the last letter or symbol that completes the spelling of a given word can score points. For an original word, points scored equal to, in a preset ratio, the total number of the letters and symbols that the word is comprised of Points scored for a modified or an extended word equal to, in a preset ratio such as 1:1 or 2:1, the total number of the additional letters and symbols needed to build a modified word, extended word, or compound word.

11. A collective word building and spelling game of claim 1 wherein a Dead End happens when a player places a letter or symbol that ends the possibility to continue making the correct spelling of any word.

12. A collective word building and spelling game of claim 1 wherein Challenge is the call made to check the spelling at the doubt of a Dead End. Anyone may call without following the playing sequence to challenge the player who has produced a possible Dead End. A Challenge can be made only against the last letter or symbol on the table at the time of calling. If the Challenge rule is adopted for the game, (a) for a successful “call to challenge”, the Caller scores points, the Callee loses the same points, other players do not score or lose any points, and that round ends; (b) for an unsuccessful “call to challenge”, i.e. the Caller loses points, the Callee scores the same points, other players do not score or lose any points, and that round continues. If the Challenge rule is adopted and the game is stalled by a possible Dead End, the referee cannot step in even if none of the players makes a Challenge call, and that round ends when all players Pass. If the Challenge rule is not adopted for the game, the player who makes a Dead End to the spelling loses points, which equal to, in a preset ratio, the total number of the letters and symbols on the table, and other players do not score or lose any points; the referee should make judgment about the Dead End proactively.

13. A collective word building and spelling game of claim 1 wherein a round ends when all players choose to pass at any time for any reasons, or when the referee calls to end the round because a Dead End has happened if the Challenge rule is not adopted for the game.
